(19) United States
(12) Patent Application Publication
(10) Pub. No.: US 2009/0034972 A1
(43) Pub. Date: Feb. 5, 2009

(54) Optical Path Routing in an Optical Communications Network

(76) Inventors: Giovanni Fiaschi, Genova (IT); Diego Caviglia, Savona (IT)

Correspondence Address: COATS & BENNETT, PLLC, 1400 Crescent Green, Suite 300, Cary, NC, 27518, US

(21) Appl. No.: 11/718,489

(22) PCT Filed: Oct. 31, 2005
(86) PCT No.: PCT/EP05/55657

§ 371 Date: Dec. 13, 2007

(30) Foreign Application Priority Data
Nov. 2, 2004 (IT) MI2004A002091

(51) Int. Cl. H04B 10/20

(52) U.S. Cl. 398/58

(57) ABSTRACT

Routing method for paths in an optical network that includes nodes having limited conversion and/or regeneration capability and in which a routing algorithm based on considerations of cost of the links is employed and in which with the nodes is associated cost information that includes conversion and/or regeneration costs. Such conversion and/or regeneration cost information is considered in the routing algorithm together with the other cost information for calculation of the routings.

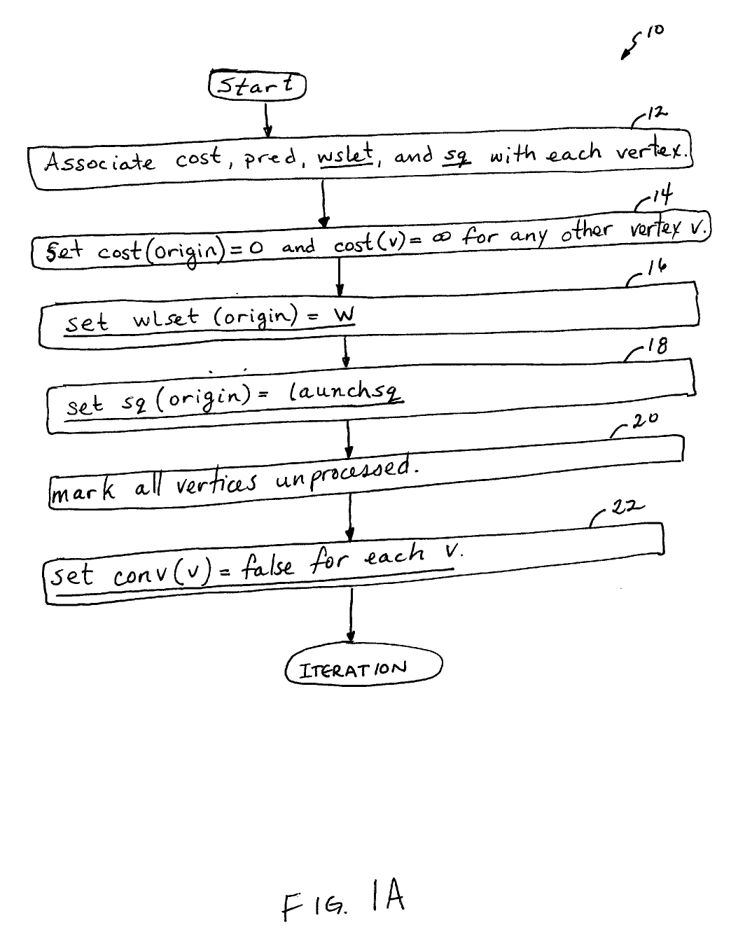

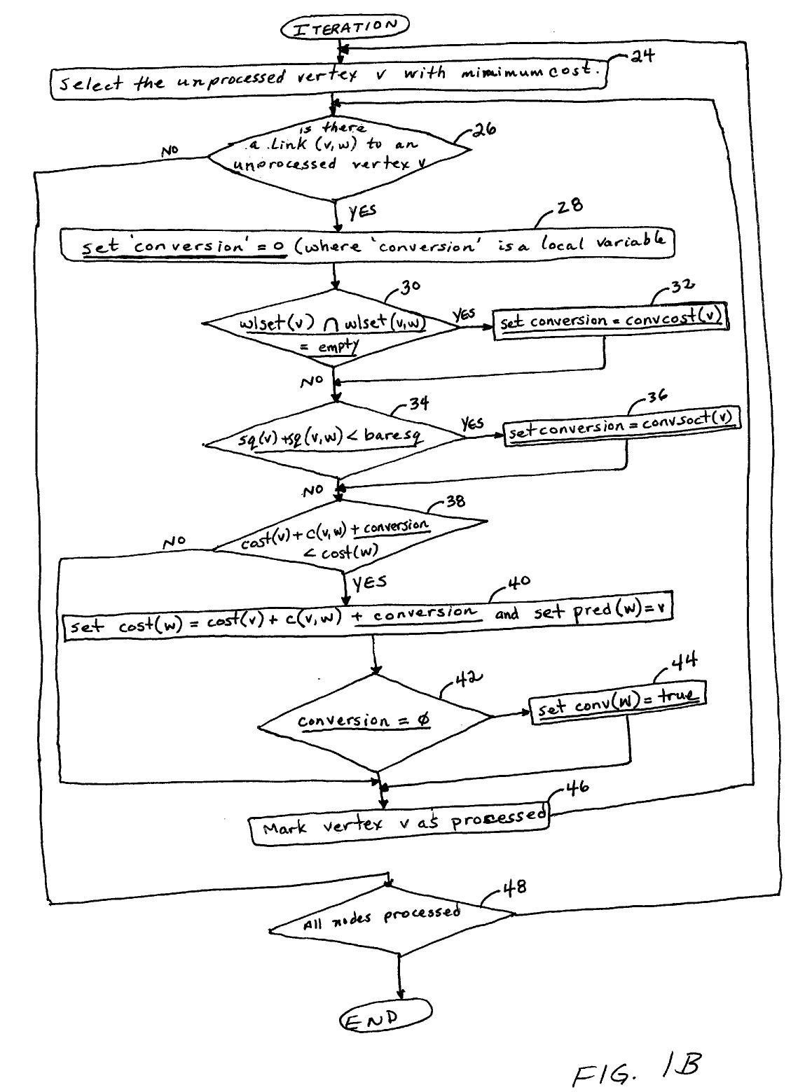

This invention relates to optical path routing in optical communications network and more especially to path routing in optical networks having limited regeneration and/or wavelength conversion.

Recent progress in optical and photonic technology have made possible the realization of all-optical networks and all-optical cross connect systems (OXC). Whilst the avoidance of the use of wavelength regeneration and conversion has clear economical advantages, all-optical networks are still subject to limitations on the length of the optical paths and wavelength contention defining the wavelength links between nodes. To lower the cost of the network, whilst avoiding complex limitations in path set up, many so-called all-optical networks comprise OXC with limited conversion/regeneration capability. Such networks require a method for routing of optical paths whilst minimizing the blocking probability of the network.

Wavelength assignment is a problem that must take into account the fact that, if no wavelength conversion is realizable through a certain number of links, the available wavelength set is the intersection of the wavelengths available on the distinct links. Thus, if a wavelength is free on one link and occupied on the link to which it is connected, it cannot be used even on the first link.

The feasibility of the path must consider all the physical limits introduced by the links to determine whether the signal is of an acceptable quality without regeneration. The signal will be subject to all the defects introduced by all the links interconnected without regeneration.

The limitations of an all-optical system can prevent formation of a circuit in many cases. For this reason, as mentioned above, it is preferred to provide a certain conversion and/or regeneration capability in the network nodes to realize ‘virtually all-optical’ networks. But to limit cost this limited regeneration/conversion capability is added in a limited amount.

Since capability is limited (as number of conversions and/or regenerations realizable simultaneously by the OXC) it is obviously important to utilize it to the best, assigning it in accordance with criteria that allow good operation of the network and at the same time minimize the chances of blocking of the network because of exhaustion of said capability in the nodes of the network.

It is therefore necessary to seek to improve routing of the optical paths to minimize the probability of blocking of the network due to exhaustion of the limited conversion and/or regeneration capabilities.

In itself, the problem of automatic routing of circuits in transport networks is well known and belongs to the fields of Network Management and Network Control Planes (ASTN and GMPLS).

This problem is generally solved with well-known routing algorithms (for example Dijkstra for centralized computation or Bellman-Ford if the information on the entire network is not available in a single point). These algorithms are applied to simple metrics aimed to minimize the cost of the path.

The object of this invention is to remedy the above mentioned shortcomings, at least in part, by making available an optical path routing method in an optical network with limited conversion and/or regeneration capability.

In accordance with the invention there is provided a routing method for paths in an optical network that includes nodes having limited conversion and/or regeneration capability and in which a routing algorithm based on considerations of cost of the links is employed and in which with the nodes is associated cost information that includes conversion and/or regeneration costs with such conversion and/or regeneration cost information being considered in the routing algorithm together with the other cost information for calculation of the routings.

Preferably, the cost of conversion and/or regeneration is a dynamic function that indicates the cost of a conversion and/or regeneration operation on the node given the quantity of occupation of the limited conversion and/or regeneration capability of the node.

Advantageously, with the nodes is associated information representing for each node the set of wavelengths that are free on all the links from the node back to the origin and stopping at the first node that performs a conversion.

Preferably, with the nodes is also associated information representing for each node the quality of the signal and accumulating the impairments introduced from all the links from the node back to a node of origin and stopping at the first node that performs a conversion.

Advantageously, with each node is associated information on cost of routing from an origin to the node with said cost information including the cost of conversion if the path requires conversion into some node from the origin to the node.

The algorithm preferably comprises the Dijkstra algorithm or the Bellman-Ford algorithm.

In a preferred implementation of the method, with the nodes is associated:
information on the set indicated by wlset, on wavelengths free on all the links from the node back to the origin and stopping at the first node that realizes conversion, and
information in the form of an sq vector and representing the quality of the signal and accumulating the limitations introduced by all the links from the node back to a node of origin and stopping at the first node that performs a conversion,
   and in the iteration of the routing algorithm that gradually considers all the unformulated v nodes to assign a cost to routing, for each link from the node considered v to an unformulated w node it is verified that:
wlset(v)∩n wlset(v,w) is an empty set, and
sq(v)+sq(v,w)<baresq, with baresq indicating the minimum acceptable signal quality,
   and, if one of the two conditions is verified, a cost of conversion and/or regeneration in the node v is added to the costs employed in the iteration.

In order that the invention and its advantages compared with the prior art can be better understood, there is described below a possible embodiment thereof by way of non-limiting example applying said principles.

As mentioned above, this invention is applicable to an optical network with a certain number of nodes and links of a type known in itself and readily imaginable to those skilled in the art with some nodes that have only limited conversion and/or regeneration capability.

To realize routing of a circuit in a data network not only the list of nodes and links to be connected must be decided, but also:
if and where to perform conversion and/or regeneration, and
which wavelength to use in the various all-optical segments, that is, segments without conversion and/or regeneration. Moreover, in the case of multiple routing possibilities, a choice must be made between the different routings with different conversion arrangements. This implies a normalization of costs to allow comparison of costs between routes with and without conversion.

The metrics to be considered include:
Each link also records the set of available wavelengths used, to evaluate set intersection among several links in a potentially all-optical segment.
Each link also records the physical optical impairments it introduces. These metrics can be rather complex, considering a number of parameters possibly independent of each other, and will be readily imaginable to those skilled in the art. They will therefore not be described here in detail. Only a vector of optical parameters will be assumed here, that is a special summation operation to accumulate their effects through several links and a Boolean function indicating for a given vector whether the light path meets the feasibility criteria. Examples of these parameters could be the Optical Signal Noise Ratio (OSNR), chromatic dispersion, Polarization Mode Dispersion mode (PMD) and others.

Since wavelength conversion also implies, de facto, regeneration of the signal and, on the other hand, in this context regeneration can be seen as wavelength conversion to the same starting wavelength, in this context the terms conversion and conversion/regeneration or regeneration will be used interchangeably.

Having defined a conversion cost, once a conversion onto a path is believed necessary (because of lack of wavelengths available on the chain of links or because of path infeasibility due to physical impairments) the conversion cost must be allowed for in the global cost of the path. The conversion cost is a parameter that can be adjusted for optimal behavior of the routing algorithm. It should be high enough to discourage conversions since conversion capabilities are limited. At the same time, in some cases certain links should be preferably avoided for some reason since their cost should be comparable to that of a conversion, that is to say, the cost of a conversion should not be incomparably higher than that of a link.

For example, in the context of a transport network, if a link fills up near to its maximum capacity it should be avoided to leave space for future circuits that have no alternative routing. Following a ‘traffic engineering’ policy, dynamic cost can be assigned to the links, which become ever higher with the increase in occupation of the link. Simulations show that such a policy leads to considerable deferring of the blocking conditions.

A similar policy can also be applied to conversion. In this case, dynamic cost functions can be associated with the conversion, with the conversion costs that increase with utilization of the conversion capability of the unit. In this manner, for example, if two equivalent routings are possible with similar costs, the algorithm will prefer the one that realizes the conversion on a more free conversion unit.

As will be seen below with an example, traffic engineering considerations can also be applied to the wavelength selection.

A routing algorithm is generally defined as a method to find a route in a graph. In particular, the input data for a routing algorithm are generally in the form of a graph G=(V,E) where V is the set of vertices (or nodes) and E is the set of edges (or links). Below, the terms node and vertex and edge and link will be used as synonyms.

A cost function c:E->N maps the links E in numbers N to assign a cost value to each link. The meaning of this is the possibility of assigning preferences to the links to favour some routes over others.

A further input is the pair of origin and destination nodes, that is to say the request to connect two nodes with a route.

Various routing algorithms can be used. By way of example, the famous Dijkstra algorithm that is considered to be the best routing algorithm known is mentioned briefly. This well-known algorithm is described by the following pseudo-code:

```
INIT
  associate cost and pred values with each vertex
  set cost(origin)=0 and cost(v)=∞ for any other vertex v
  mark all vertices unprocessed
ITERATION
  select the unprocessed vertex v having minimum cost
  for each link (v,w) to an unprocessed vertex w, do
      if cost(v)+c(v,w)<cost(w) then
        set cost(w)=cost(v)+c(v,w)
        set pred(w)=v
      endif
  mark v processed
ITERATION continues until all the nodes have been processed.
```

At the end of iteration, Cost(destination) contains the cost of the routing found. The route can be followed backward from destination over pred(destination), pred(pred(destination)) and so forth back to the node of origin.

To use the algorithm more realistically, traffic-engineering considerations can be added. To do this, another capability:E->N function will map the E links in an N FIGURE indicating the bandwidth supported by the link. A ‘requested capacity’ FIGURE is also added to the circuit request and, when the circuit is set up, its capacity is recorded on the links that it interconnects, to record the occupied and free bandwidths on the links. A dynamic cost function can be used instead of a static function to apply an increasing cost as the free (available) bandwidth reduces.

Other algorithms based on the same data structures as the Dijkstra algorithm are well known and the invention is thus directly applicable thereto. Indeed, as this invention concerns in particular data structures, information and manners of comparing costs and not on a specific algorithm, it can be readily applied even to these other algorithms. In particular, it was found advantageous to apply this invention to the known Bellman-Ford algorithm.

For reasons of simplicity and clarity, reference is made below to the pseudo-code described above for the Dijkstra algorithm even though the principles of this invention are not linked to a specific algorithm. For those skilled in the art, application to the Belmann-Ford is directly inferable from the following description with no need of other information or descriptions.

As mentioned above, in a network including nodes with limited conversion and/or regeneration capability, the algorithm is modified to allow for the existence of these limited capabilities (whose use involves a ‘cost’ for the network) in computation of the routings.

In accordance with this invention, cost information including a conversion and/or regeneration cost is associated with the nodes. This conversion and/or regeneration cost information is considered in the routing algorithm together with the other cost information for calculation of the routings.

Advantageously, the conversion and/or regeneration cost is a dynamic cost function (convcost) indicating the cost of a conversion operation on that node given the occupation of the conversion unit.

The cost information kept on each node is thus a cost that represents (as for example in the normal Dijkstra algorithm described above) the cost of routing from the origin to the node. Unlike the known cost, this cost also includes the cost of conversion if the path requires conversion in some node from the origin to this node.

Associated with each node there will also be information on the set of available wavelengths. Said set (designated below wlset) represents the wavelengths that are free on all links from this node backward to the origin and stopping at the first node performing a conversion. Since W is the set of all the wavelengths used in the network, a path starts with wlset(v)=W if v is either the origin or the node performing the conversion.

There will also be the information (in the form of a vector, designated below by sq) that represents the quality of the signal which accumulates the impairments introduced by all the links from the node backward to the node of origin and stopping at the first node that performs a conversion. From a node v that is the origin or a node performing a conversion and/or regeneration the signal starts as new with a FIGURE indicated by launchsq:sq(v)=launchsq. In addition, to meet the feasibility criteria the quality of the signal must not be worse than a specified value baresq; to facilitate notation, sq(v)<baresq will be written where the comparison operator ‘<’ indicates a possible comparison of complex vectors.

As far as stated above, in addition to the known data and information structures it will also be useful to have available, in accordance with the principles of this invention, the following further information and additional data structures:
the set W of all wavelengths used in the network,
the set of available wavelengths for each link,
the set of wavelengths used for each link,
a vector of the physical impairments introduced by the link,
a conversion capacity value for each node,
an occupation value for the conversion unit, and
an occupation value for each wavelength ‘fabric’.

Wavelengths available and used also account for the capacity of the link. The number of free wavelengths can be used to calculate the dynamic cost of the link.

Applying the described principles of this invention, the pseudo-code given above for the Dijkstra algorithm becomes (the added parts are underlined for convenience):

```
INIT
  associate cost, pred, wlset, and sq with each vertex
  set cost(origin)=0 and cost(v)=∞ for any other vertex v
  set wlset(origin)=W
  set sq(origin)=launchsq
  mark all vertices unprocessed
  set conv(v)=false for each v
ITERATION
  select the unprocessed vertex v with minimum cost
  for each link (v,w) to an unprocessed vertex w, do
      set conversion=0 (where conversion is a local variable)
      if wlset(v)∩wlset(v,w)=empty then setconversion=convcost(v)
      if sq(v)+sq(v,w)<baresq then setconversion=convcost(v)
    if cost(v)+c(v,w)+conversion<cost(w) then
        set cost(w)=cost (v)+c(v,w)+conversion
        set pred(w)=v
        if conversion is not equal to 0 then set conv(W)=true
      endif
  mark v as processed
ITERATION continues until all nodes have been processed.
```

In a node, the variable pred designates the previous node in the calculated routing and the Boolean variable conv indicates whether the previous node performs a conversion.

By way of explanation, a possible structure of a known optical cross connect (OXC) present in a node of a network is described here. If it is desired to use ‘all optical’ technologies, such an OXC usually consists of a set of wavelength division and multiplexing (WDM) interfaces with optical multiplexers exposing WDM fibres to the network (a fibre corresponds to a network link) and single wavelengths to an optical matrix (optical fabric) that performed the link. The optical matrix is assumed to be ‘non-blocking’, that is to say any wavelength from any interface can be moved to the same wavelength as any other interface.

To allow choice of wavelength when accessing the network, a wavelength selection module is placed between the tributary section and the optical matrix.

The optical matrix of the node can be considered, according to a well known technique, implemented in separate planes, one for each wavelength. This does not result in a loss of generality of the method described here since lack of wavelength conversion keeps the wavelengths separated anyway.

To remedy the fact that the optical matrix does not have wavelength conversion and/or regeneration capability, a known conversion and/or regeneration unit is inserted in the OXC to realize a virtually all-optical node. For example, again in accordance with the prior art, the conversion and/or regeneration unit can be implemented with an electrical switch or an optical switch with transponders on each access interface (OEOEO). These units also implement the selection function on tributary interfaces.

A plane with a certain wavelength can therefore be thought of as including a transparent non-blocking optical switch, a number of accesses to optical multiplexers, one per network link, and a small number of accesses to a conversion and/or regeneration unit.

It is clear that there can be different conversion opportunities since each wavelength plane has a certain number of access interfaces to the conversion unit. As mentioned above, traffic engineering considerations can also be applied to the selection of wavelengths.

For example, assume that λ₁ and λ₂ are both free for an inlet path requiring conversion. Assume also that the λ₁ optical fabric is already full of transit links without conversion and that the λ₂ optical fabric is empty. It is much more probable that future requirements will ask the conversion unit for a 22 access while there will probably not be another request for λ₁. Therefore, a criterion in the choice of the wavelength on the conversion node could be to choose a fuller wavelength plane. Such a strategy could be generalized without effort as easily imaginable to those skilled in the art without further description.

For each segment found without routing conversions, if more wavelengths are available in the segment, one chooses advantageously the one with the optical matrix of the plane of the frequencies more fully occupied at both end nodes of the segment.

As easily verifiable, the Dijkstra algorithm modified to apply the method in accordance with this invention allows obtaining assignment of routing costs to the various nodes that allows for the choice of lesser overall cost (of the paths and use of conversion and/or regeneration resources).

It is now clear that the preset purposes have been achieved by making available a routing method applicable to various known routing algorithms to be able to optimize routing in the presence of limited conversion and/or regeneration capability in the network.

Naturally the above description of an embodiment applying the innovative principles of this invention is given by way of non-limiting example of said principles within the scope of the exclusive right claimed here.

1-7. (canceled)

8. A routing method for paths in an optical network having nodes with limited conversion and/or regeneration capability, the routing method being based on cost considerations of one or more links between the nodes and comprising the steps of:
associating cost information with each node in an optical network, the cost information including a conversion cost;
associating signal quality information with each of the nodes in the optical network, the signal quality information comprising a vector sq that represents the quality of a signal received at a given node as the signal was affected by the accumulated impairments introduced by one or more links between the given node, and one of a node of origin and a node that performed a conversion; and
calculating a route between the nodes in the optical network based on the conversion costs and the signal quality.

9. The method of claim 8 wherein the conversion cost comprises a dynamic function that indicates the cost of a conversion operation on a node based on a quantity of occupation of the limited conversion capability of the node.

10. The method of claim 8 further comprising associating wavelength information with each of the nodes in the optical network, the wavelength information representing a set of wavelengths that are free on all links between the given node and one of the node of origin and the node that performed the conversion.

11. The method of claim 8 further comprising associating information indicating a cost of routing from the node of origin to the given node, and wherein the cost information includes the conversion cost if a path requires conversion at an intermediate node between the node of origin and the given node.

12. The method of claim 8 wherein calculating a route between the nodes in the optical network comprises using a Dijkstra algorithm.

13. The method of claim 8 wherein calculating a route between the nodes in the optical network comprises using a Ballman-Ford algorithm.

14. The method of claim 8 further comprising associating wavelength information with each of the nodes in the optical network, the wavelength information representing a set of wavelengths wlset that are free on all links between the given node and one of the node of origin and the node a first node that performed the conversion.

15. The method of claim 14 wherein the vector sq indicates the quality of the signal as the signal was affected by the impairments introduced by the one or more links between the given node and one of the node of origin and the node that performed a first the conversion;

16. The method of claim 14 further comprising iteratively assigning a routing cost to each unformulated node.

17. The method of claim 16 further comprising, for each link between a first unformulated node v and a second unformulated w, verifying that:
wlset(v)∩wlset(v,w) comprises an empty set; and
sq(v)+sq(v.w)<baresq, wherein baresq indicates a minimum acceptable signal quality;

18. The method of claim 17 further comprising adding the conversion cost associated with the node v to the costs at each iteration if wlset(v)∩wlset(v,w) or if sq(v)+sq(v.w)<baresq.

19. The method of claim 8 wherein the conversion cost indicates a cost associated with converting a wavelength to a signal at a node.

20. The method of claim 8 wherein the conversion cost indicates a cost associated with converting a signal to a wavelength at a node.
